(19) United States
(12) Patent Application Publication
(10) Pub. No.: US 2008/0016084 A1
(43) Pub. Date: Jan. 17, 2008

(54) Multifunction peripheral and user information management method thereof

(75) Inventor: Tomofumi Takagi, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/822,067

(22) Filed: Jul. 2, 2007

(30) Foreign Application Priority Data
Jul. 3, 2006 (JP) 2006-183717

(51) Int. Cl. G06F 17/30

(52) U.S. Cl. 707/10

(57) ABSTRACT

User information is associated with a user ID and registered in an LDAP server and in a multifunction peripheral. A user can acquire and use the information at the time of transmission processing.

### CROSS-REFERENCE TO RELATED APPLICATIONS

This application claims priority under 35 U.S.C. 119 to Japanese Patent Application No. 2006-183717, filed on Jul. 3, 2006, which application is hereby incorporated by reference in its entirety.

### BACKGROUND OF THE INVENTION

1. Field of the Invention

The present invention relates to a multifunction peripheral, and in particular, to user information management by using an LDAP server.

2. Description of the Related Art

A multifunction peripheral provided in a LAN uses an information management server such as LDAP (Lightweight Directory Access Protocol) servers, and shares user information. In an LDAP server, entries of information such as user information and registration items such as attributes constituting the information are defined in advance. Accordingly, in an LDAP server, data of the item other than the predetermined registration items cannot be registered. In order to add attributes in an LDAP server, the schema must be extended.

### SUMMARY OF THE INVENTION

In order to overcome the problem described above, an object of the present invention is to enable management of arbitrary information for each user by registering data of user information of the item other than predetermined registration items of a LDAP server in a multifunction peripheral in a LAN.

A multifunction peripheral according to the present invention includes an acquiring unit, a first registration unit, a second registration unit, a management unit, and a transmit document preparing unit. The acquiring unit acquires user information managed in an LDAP server. The first registration unit registers data of a predetermined registration item of user information in the LDAP server. The second registration unit registers data of an item other than the predetermined registration item in the multifunction peripheral while associating the data with the data registered in the LDAP server. The management unit manages the user information registered in the LDAP server and the user information registered in the multifunction peripheral while associating them with each other. The transmit document preparing unit prepares a transmit document in which user information acquired from the LDAP server and user information registered in the multifunction peripheral which is associated with the user information in the LDAP server are included in transmit data as source information of the user at the time of transmission processing.

Preferably, the user information registered in the multifunction peripheral includes image data for each user.

Further, the present invention provides an information management method including an acquisition step, a first registration step, a second registration step, and a transmit document preparing step. In the acquisition step, user information managed in an LDAP server is acquired. In the first registration step, data of a predetermined registration item of the user information is registered in the LDAP server. In the second registration step, data of an item other than the predetermined registration item is registered in the self machine while being associated with the data registered in the LDAP server. In the transmit document preparing step, a transmit document is prepared in which user information acquired from the LDAP server and user information registered in the self machine which is associated with the user information in the LDAP server are included in transmit data as source information of the user at the time of transmission processing.

According to the present invention, data of the items not corresponding to the registration items of the LDAP server or items involving difficulties in registration can be used in an integrated manner by registering arbitrary data of user information in a multifunction peripheral while corresponding it with the LDAP server. Since information for each user is registered by being associated in the LDAP server and in the multifunction peripheral, the user can use data acquired from the LDAP server or from the multifunction peripheral. Further, according to the present invention, the user information acquired from the LDAP server and from the multifunction peripheral can be used as source information of the user at the time of transmission processing.

According to the present invention, the user information registered in the multifunction peripheral can include image data. Thereby, electronic data of seal impression for each user and/or signature information for each user can be registered. Further, a cover sheet or the like for a transmit document can be registered. These kinds of information can be used at the time of transmission processing.

According to the present invention, the user information registered in the LDAP server and the user information registered in the multifunction peripheral are corresponded with each other by means of a user ID, so search or the like can be performed easily.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a configuration of a multifunction peripheral according to an embodiment.

FIG. 2 illustrates a table including information managed by an LDAP server in the embodiment.

FIG. 3 illustrates a user information management table of the embodiment.

FIG. 4 schematically illustrates a transmit document prepared by using data of the LDAP server and data of the multifunction peripheral in the embodiment.

FIG. 5 is a flowchart illustrating a processing algorithm for performing processing relating to user information in the embodiment.

### DETAILED DESCRIPTION OF PREFERRED EMBODIMENTS

A preferred embodiment of the present invention will be described below.

### (Embodiment)

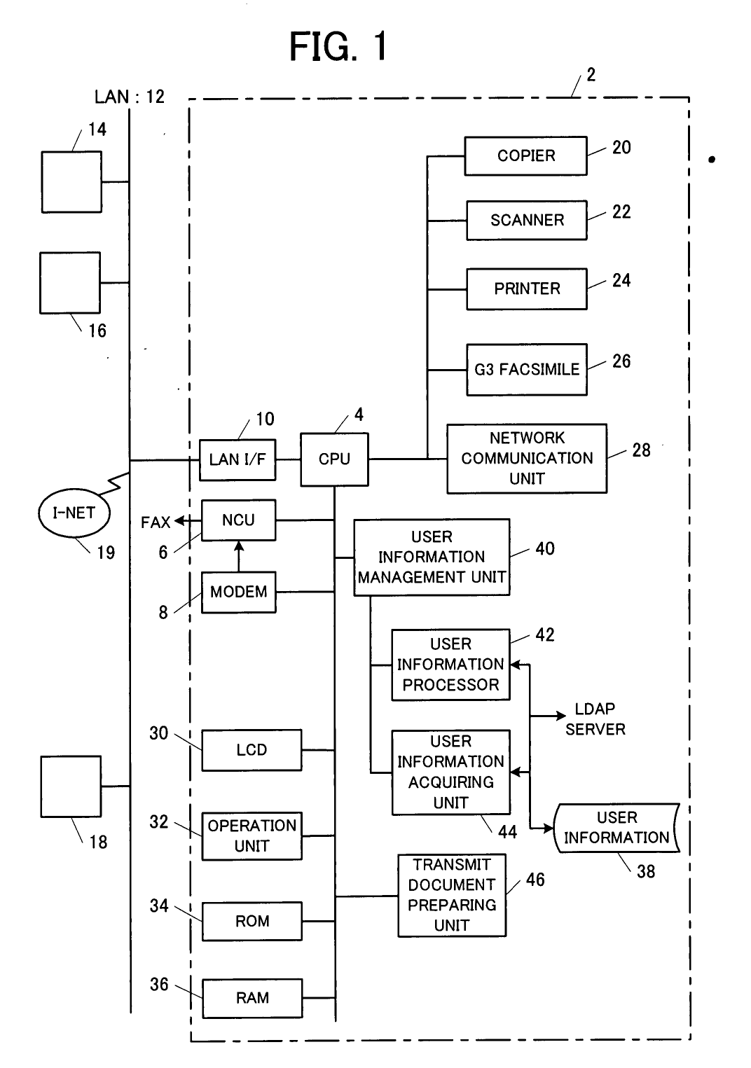

FIGS. 1 to 5 illustrate an embodiment. FIG. 1 illustrates the configuration of a multifunction peripheral 2, including a CPU 4 as a main controller, a network control unit (NCU) 6 for establishing a call to the public telephone network, and a modem 8 for transmitting/receiving G3 facsimile data or the like over the public telephone network.

The multifunction peripheral 2 is connected with an LDAP server 14, which is an external device, via a LAN interface 10 and a LAN 12. Further, the multifunction peripheral 2 is connected with personal computers 16, 18 etc. owned by users, which are external devices, via the LAN interface 10 and the LAN 12. Note that the Internet is denoted by the reference numeral 19.

In the multifunction peripheral 2, a copy function processor 20 performs copying by using a scanner for reading a document and converting it into image data and a printer for hard-copying image data. A scanner function processor 22 reads images with a scanner and performs processing such as transmission of image data to a personal computer or the like. A printer function processor 24 assigns a network printer function to a printer so as to perform printing and the like as a network printer in response to requests from personal computers 16, 18 etc, within the LAN 12. A G3 facsimile function processor 26 performs transmission/reception of conventional G3 facsimile through the public line network (public telephone network). A network communication unit 28 performs transmission/reception of Internet facsimile, e-mails and the like.

A display panel such as an LCD is denoted by the reference numeral 30, and an operation/input unit is denoted by the reference numeral 32. A user can select processing of G3 facsimile and/or e-mail transmission, and can input setting conditions of transmission processing, by using a touch panel of the LCD display panel, a keyboard, and the like. Further, by using the touch panel of the LCD display panel and the keyboard, the user inputs user identification information such as a user ID and/or a user name to thereby acquire (search) user information from the LDAP server 14 or the like.

Further, a transmission instruction may be given from a personal computer 16 with a screen similar to the display panel 30 displayed on the personal computer 16 or the like. In such a case, the personal computer 16 can acquire user information from the LDAP server 14 and/or the multifunction peripheral 2. Note that a ROM for storing programs and the like is denoted by the reference numeral 34, and a RAM for storing various kinds of data, such as a user information management table 38, is denoted by the reference numeral 36.

A user information management unit 40 includes a user information processor 42 and a user information acquiring unit 44. The user information processor 42 is for performing processing such as registration/deletion/update of user information on the LDAP server 14 and the table 38 by using a user ID. The user information acquiring unit 44 is for acquiring user information from the LDAP server 14 and the table 38. A transmit document preparing unit 46 prepares a G3 facsimile document and/or an Internet facsimile document using the user information acquired from the LDAP server 14 and the table 38 by using the user information acquiring unit 44. In the embodiment, the user is a transmitter, and when the user prepares and transmits a transmit document, the user acquires information on himself/herself stored in the LDAP server 14 and in the multifunction peripheral 2, and uses it as source information.

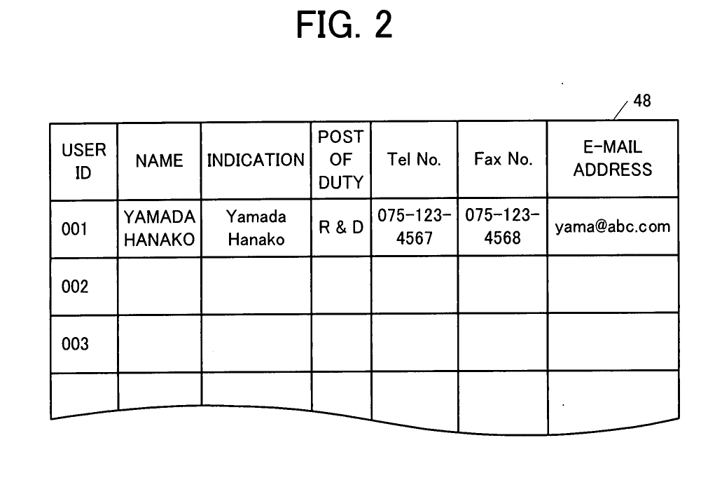

FIG. 2 is a user information management table 48 provided in the LDAP server 14 of the embodiment. The user information management table 48 shows registration items of user information and their values. In the table 48, a user ID is allocated to each user, and transmit information for each user is managed. In the LDAP, data is stored in a directory information tree (DIT) structure, and a group of data is handled as an entry with attributes and attribute values. The mandatory attributes are defined in advance according to the type of each entry. If an entry is user information, “name”, “indication” and the like are the management items (mandatory attributes). The table 48 shows the mandatory attributes and their attribute values in the embodiment.

Processing to add an attribute to the entry accompanies schema extension, so it is troublesome. Therefore, in the embodiment, arbitrary items other than predetermined registration items of the LDAP server 14 are registered for each user in the multifunction peripheral 2. Thereby, management items (attributes) of user information can be added without adding attributes to the LDAP server 14.

For example, a search through the LDAP server 14 and the multifunction peripheral 2 can be conducted based on the first to fourth retrieval conditions. The first retrieval condition is to find user information (entry). The second retrieval condition is which attribute of the user information is to be acquired. The third retrieval condition is whether the specified attribute is present. Further, the fourth retrieval condition is whether the specified user ID (item value) coincides.

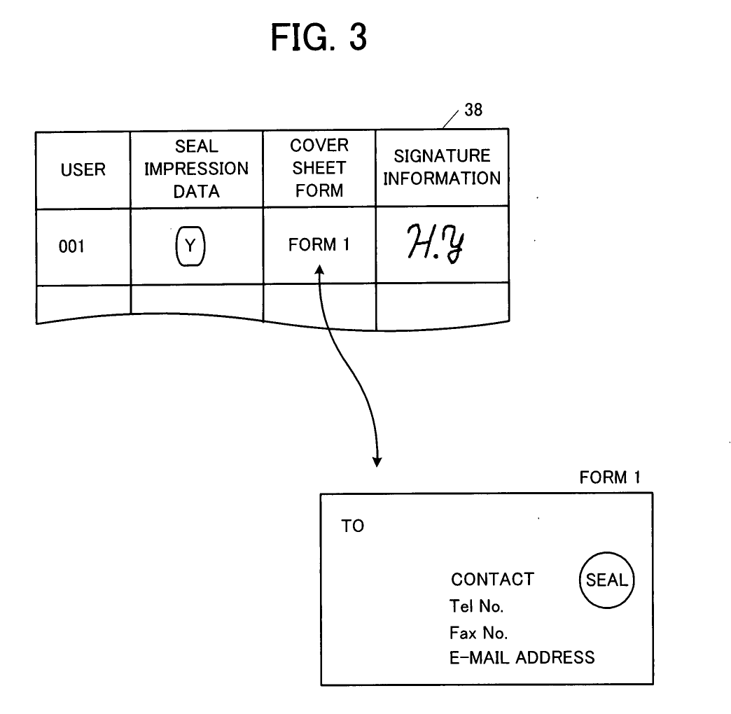

FIG. 3 illustrates a user information management table 38 in which user information of the multifunction peripheral 2 is registered. Arbitrary items which cannot be registered in the LDAP server, among the user information, are registered and managed in the multifunction peripheral 2. Arbitrary user information can be registered in the multifunction peripheral 2. In the present embodiment, pieces of image data including “seal impression data”, “cover sheet form” and “signature information” are registered. The user can acquire item values corresponding to the user ID at the time of transmission processing. The item values managed by the LDAP server 14 can be acquired by searching the LDAP server 14 by using the user ID. The item values managed by the multifunction peripheral 2 can be acquired by searching the multifunction peripheral 2 by using the user ID. Note that the user can use a unique cover sheet for him/her by registering the self information in the table 38, and can also use his/her seal impression data or signature. Thereby, the transmitter and the transmit document can be confirmed on the transmit document receiving side.

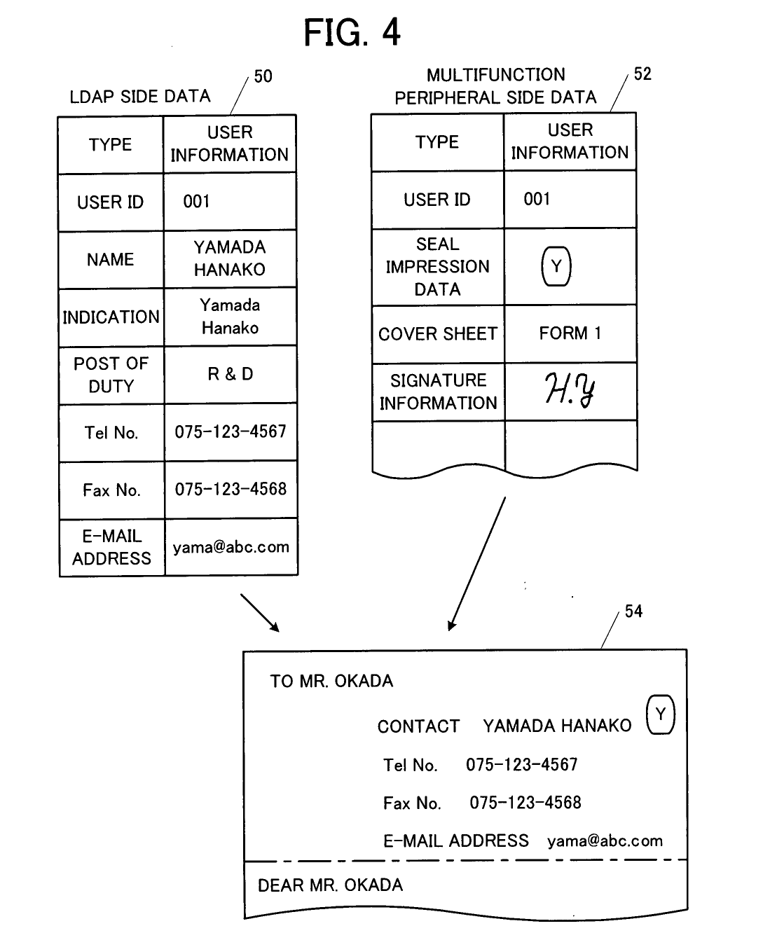

FIG. 4 schematically illustrates a transmit document prepared by a user (user ID: 001) using his/her user information. The user acquires user information 50 registered in the LDAP server 14 and user information 52 registered in the multifunction peripheral 2 by using his/her user ID. Then, in a predetermined area of a cover sheet form 1 specified in the user information 52, the user fills in the information acquired from the user information 50 and from the user information 52 to thereby prepare a transmit document 54. For example, when the user prepares the transmit document 54, information such as the name in the user information 50 and the seal impression data in the user information 52 can be entered. Thereby, the user is only required to input a destination and the content of the transmit document, and the user need not select a cover sheet form and input the source information each time he/she performs transmission processing. By registering user information for each user in the LDAP server 14 and in the multifunction peripheral 2, a user can easily prepare a transmit document by using arbitrary information.

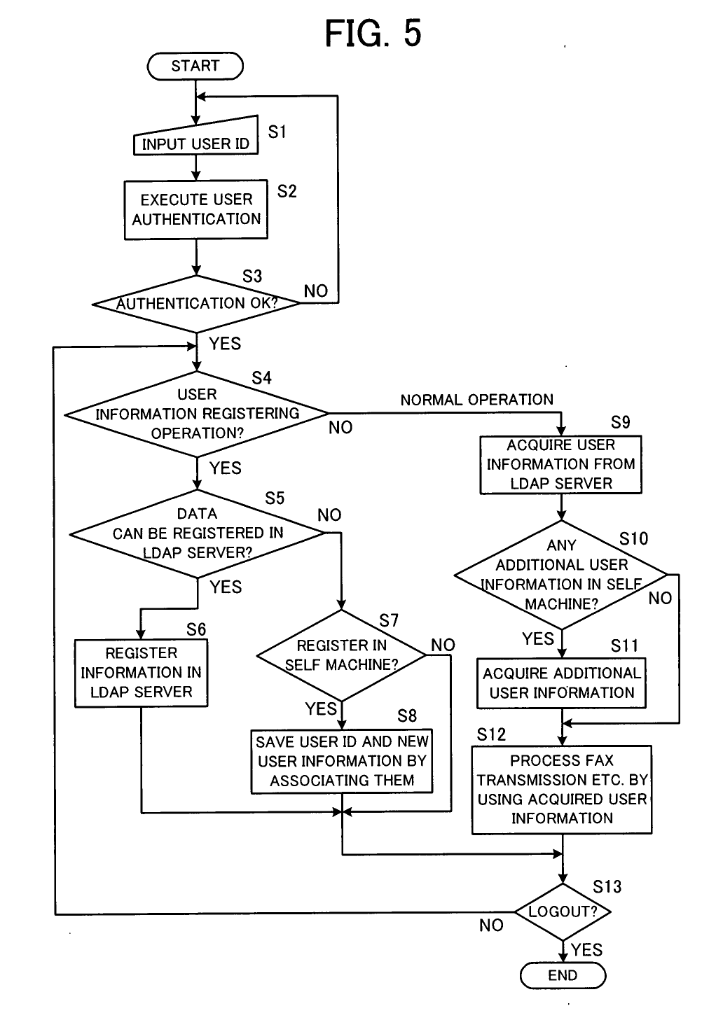

FIG. 5 illustrates processing to register and acquire user information in the multi function peripheral of the embodiment. A user inputs login authentication information including a user ID to the multifunction peripheral 2 and transmits the authentication information to the LDAP server 14, and requests the LDAP server 14 for login authentication (S1 to S3). If the authentication is completed normally, the user can perform subsequent processing by using his/her user information used for the authentication. When the authenticated user performs processing to register the user information, then it is checked whether the user information can be registered in the LDAP server 14, that is, whether it corresponds to the registration item (S4, S5). If it is the registration item of the LDAP server 14, the user information is registered to the corresponding item (S6). If the user information does not correspond to the registration item of the LDAP server 14 but is the information desired to be managed at the multifunction peripheral 2, the information is registered by being associated with the user ID in the user information management table 38 of the multifunction peripheral 2 (S7, S8).

When the user performs transmission processing in the multifunction peripheral, the user first acquires user information associated with the user ID from the LDAP server 14 (S9). Further, the user checks whether information relating to the user is registered in the multifunction peripheral 2, and when there is any corresponding information, the user acquires it as additional user information (S10, S11). Then, the user prepares a transmit document by using the acquired information, and performs transmission processing and the like (S12). Such processing can be performed repeatedly until the user logs out (S13). In the embodiment, although the user information is used as source information when transmitting a facsimile message and an e-mail, the user information may be acquired in a similar manner when performing other processing in the multifunction peripheral 2.

In the embodiment, since user information is managed in the LDAP server 14 and in the multifunction peripheral 2 connected with the network, data of the items which cannot be registered in the LDAP server 14 can be used by being registered in the multifunction peripheral 2. Therefore, it is possible to register various kinds of information such as seal impression data and/or signature information for each user and to attach it to a transmit document. Thereby, the source can be confirmed on the receiving side. Further, by registering a cover page form and the like, a unique cover page for a user can be used easily. The source information acquired is filled in the cover page form acquired simultaneously, so the user can perform transmission processing easily.

Information which cannot be registered or is difficult to be registered in the LDAP server 14 can be managed in the multifunction peripheral 2 within the LAN. Accordingly, a user can use various kinds of information relating to the user, registered dispersedly in the network, in an integrated manner. Further, the information on each user in the LDAP server 14 and the information on each user in the multifunction peripheral 2 have been registered while being associated with each user ID. Therefore, user information can be searched easily.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A multifunction peripheral, comprising:
an acquiring unit for acquiring user information managed in an LDAP server;
a first registration unit for registering data of a predetermined registration item of user information in the LDAP server;
a second registration unit for registering data of an item other than the predetermined registration item in the multifunction peripheral while associating the data with the data registered in the LDAP server;
a management unit for managing the user information registered in the LDAP server and the user information registered in the multifunction peripheral while associating them with each other; and
a transmit document preparing unit for preparing a transmit document in which user information acquired from the LDAP server and user information registered in the multifunction peripheral which is associated with the user information in the LDAP server are included in transmit data as source information of a user at the time of transmission processing.

2. The multifunction peripheral according to claim 1, wherein the user information registered in the multifunction peripheral includes image data for each user.

3. The multifunction peripheral according to claim 2, wherein the image data for each user includes seal impression data.

4. The multifunction peripheral according to claim 2, wherein the image data for each user includes image data of a cover sheet for the transmit document.

5. The multifunction peripheral according to claim 2, wherein the image data for each user includes image data of signature information.

6. The multifunction peripheral according to claim 1, wherein the management unit associates the user information in the LDAP server and the user information registered in the multifunction peripheral by means of a user ID.

7. The multifunction peripheral according to claim 6, further comprising an authentication unit for requesting the LDAP server for login authentication by using the user ID, wherein
the transmit document preparing unit performs transmit document preparing processing repeatedly until logout, by using the user ID inputted at the time of the login authentication.

8. A method of managing information, comprising:
an acquisition step for acquiring user information managed in an LDAP server;
a first registration step for registering data of a predetermined registration item of user information in the LDAP server;
a second registration step for registering data of an item other than the predetermined registration item in a self machine while associating the data with the data registered in the LDAP server; and
a transmit document preparing step for preparing a transmit document in which user information acquired from the LDAP server and user information registered in the self machine which is associated with the user information in the LDAP server are included in transmit data as source information of a user at the time of transmission processing.

9. The method of managing information according to claim 8, wherein
the user information registered in the self machine includes image data for each user.

10. The method of managing information according to claim 9, wherein the image data for each user includes seal impression data.

11. The method of managing information according to claim 9, wherein the image data for each user includes image data of a cover sheet for the transmit document.

12. The method of managing information according to claim 9, wherein the image data for each user includes image data of signature information.

13. The method of managing information according to claim 8, wherein in the second registration step, the user information in the LDAP server and the user information registered in the self machine are associated with each other by means of a user ID.

14. The method of managing information according to claim 13, further comprising an authentication step for requesting the LDAP server for login authentication by using the user ID, wherein
in the transmit document preparing step, transmit document preparing processing is performed repeatedly until logout, by using the user ID inputted at the time of the login authentication.
